(19) United States
(12) Patent Application Publication
(10) Pub. No.: US 2016/0327127 A1
(43) Pub. Date: Nov. 10, 2016

(54) Automatic gearbox

(71) Applicant: Scripcariu Ion, Uzun Village (RO)

(72) Inventor: Scripcariu Ion, Uzun Village (RO)

(21) Appl. No.: 14/756,377

(22) Filed: Sep. 3, 2015

(30) Foreign Application Priority Data
May 4, 2015 (RO) A/00312

(51) Int. Cl. F16H 3/091; F16D 41/00

(52) U.S. Cl. CPC F16H 3/091; F16D 41/00

(57) ABSTRACT

This invention refers to an automatic gearbox, intended for equipping low and high power road vehicles, including heavy-duty tip lorries, as well as any other motor tools. The gearbox, according to this invention, is made up of a ball hydraulic clutch (1) tied in with a primary shaft (5) provided with some toothed wheels (6 and 7) which engage some crown wheels (9 and 10) of some freewheeling clutches with pressure balls (A) which are mounted on an intermediary shaft (12) and are provided with crown wheels (33 and 34) and with toothed wheels (19, 20, 21, 22 and 23) which are tied in with these. Both the crown wheels (33 and 34), and the toothed wheels (19, 20, 21, 22 and 23) on the intermediary shaft (12) engage, in their turn, some toothed wheels (6, 7, 31 and 32) and some crown wheels (33, 34, 35 and 36) on some freewheeling clutches (B, C and D) on the final shaft (27). The two shafts (12 and 27) are provided with pressure chambers (15, 16, 39 and 40) connected hydraulically and supplied with pressure oil from a hydraulic distributor (55) which has a hydraulic accumulator (F) and a pressure regulator (E) attached to an oil pump (4) equipped with a toothed wheel (3) which is engaged by another toothed wheel (2). The hydraulic accumulator (F) is made up of a cylindrical element (56) which is assembled through threading with a number of secondary elements (58), which are also threaded among them. Inside and along their axis there is a gliding rod (57) with a piston (u) which glides inside the cylindrical elements (56).

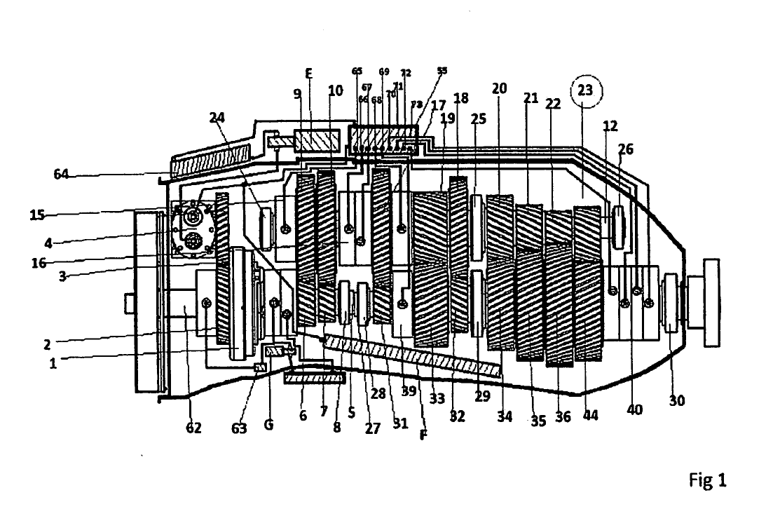

The Summary will be published together with FIG. 1.

This invention refers to an automatic gearbox, intended for equipping low- and high-powered road vehicles, including heavy duty tip lorries, as well as any other tools equipped with an engine.

An automatic gearbox with two shafts and freewheeling clutch is known, where the power of the engine is transmitted through clutches.

The disadvantage of these technical solutions is that they can't be applied for high powers.

The technical problem solved by this invention consists in creating an automatic gearbox which allows the power to be transmitted via freewheeling clutches and elements of control and automation of their components and movements which, will bring about an increased reliability and a larger domain of use.

The automatic gearbox, according to this invention, removes the above-mentioned disadvantages due to the fact that it includes a ball hydraulic clutch tied in with a primary shaft provided with toothed wheels which engage the crown wheels of some freewheeling clutches with pressure balls which are mounted on an intermediary shaft and are provided with crown wheels, as well as with some toothed wheels tied in with these. Both the crown wheels and the toothed wheels on the intermediary shaft engage the crown wheels and the toothed wheels of the freewheeling clutches on the final shaft. The two shafts are provided with pressure chambers which are connected hydraulically and are supplied with pressure oil from a hydraulic distributor provided with a hydraulic accumulator and a pressure regulator attached to an oil pump which is provided with a toothed wheel engaged by another toothed wheel. The drums belonging to the crown wheels are provided with radial holes in steps, of different radiuses, into which slide some pistons provided each with a seat where some pressure balls are placed. The pressure balls are retained on a radial direction by a limiting ring. The drums of the crown wheels are provided with pistons and balls arranged on two rows with a deviation of half a step between them. The drum of the crown wheel is provided with three rows of pistons and balls, the middle row having a deviation of half a step as compared to the lateral rows. The freewheeling clutch with pressure balls mentioned above, belonging to the crown wheel, has a drum provided with a row of radial grooves which correspond to some radial rectangular seats through which slide some cylindrical pistons ending with a rectangular section, pressed by spiral springs, each sitting on a rectangular metal element which is provided with an axial groove, the cylindrical pistons being into contact with some balls. The pressure regulator is made up of a main element and a secondary element which are assembled together by threading. Inside and along their axis moves a gliding rod provided with a stopping disc which is pressed by a spiral spring which sits on the secondary element. Inside the rod there is an axial groove which allows the oil to pass through the threaded port of the main element into the secondary element. The hydraulic accumulator is made up of a cylindrical element provided with a threaded port and a reservoir where the pressure oil is stored. The cylindrical element is assembled by threading with other secondary elements, which are also assembled between them by threading. Inside and along their axis moves a gliding rod provided with a piston which glides inside the cylindrical elements. The gliding rod also has some circular grooves into which some plates are coupled. A number of spiral springs, grouped into pairs, press these plates and sit independently upon the secondary elements, forming a force couple.

The automatic gearbox, according to this invention, has the following advantages:
changing the gears without shock;
reduced fuel consumption;
instant gear changing;
long operation duration;
smaller constructive sizes;
due to the blocking between gears, the vehicle is also blocked and it does not need braking; to start the vehicle again it is enough to accelerate.

Below is presented an example of execution of this invention also in connection with FIG. 1-13 which show respectively:

FIG. 1, general view of the automatic gearbox, according to the invention;

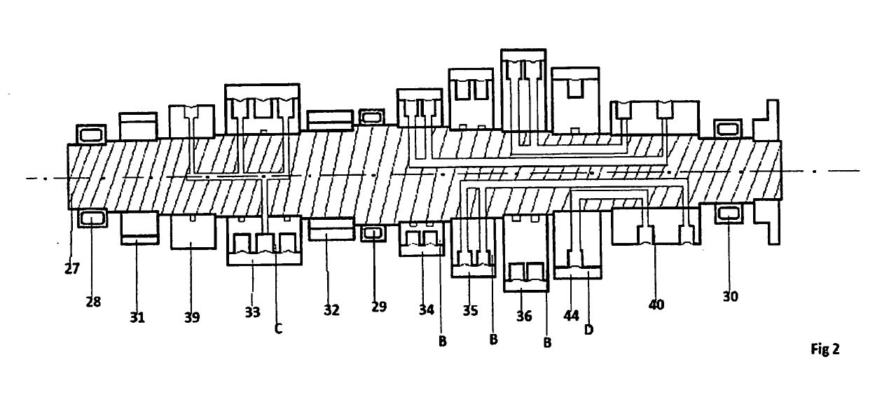

FIG. 2, axial section through the final shaft of the automatic gearbox, according to the invention;

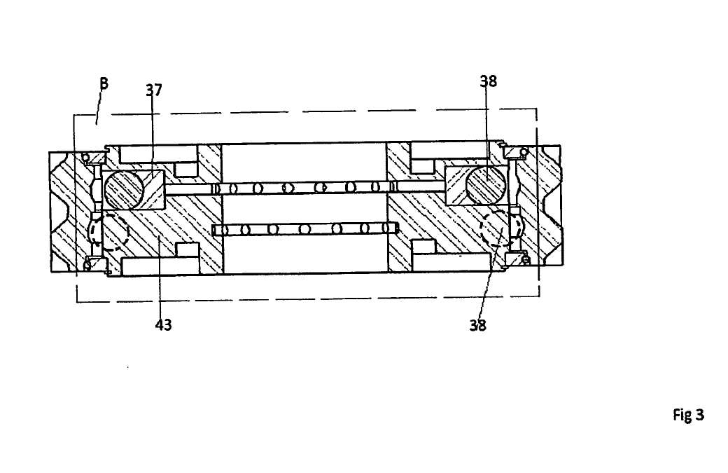

FIG. 3, axial section through the coupling with two rows of balls pos. B;

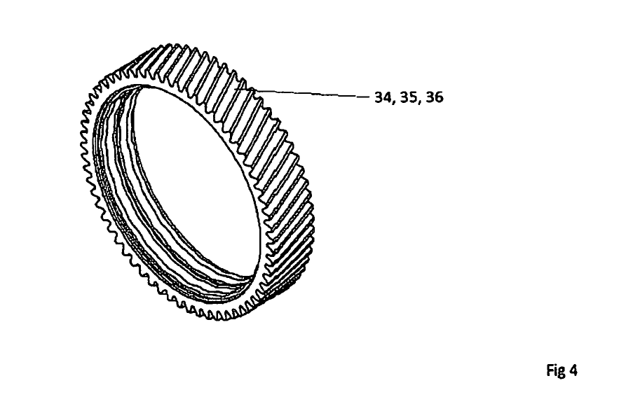

FIG. 4, perspective view of the crown wheels pos. 34, 35 and 36

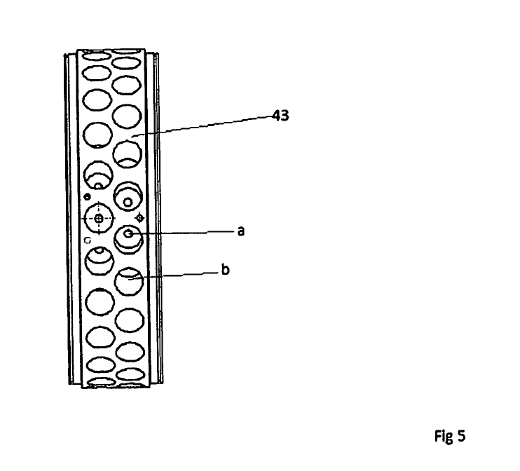

FIG. 5, lateral view of the drum pos. 43;

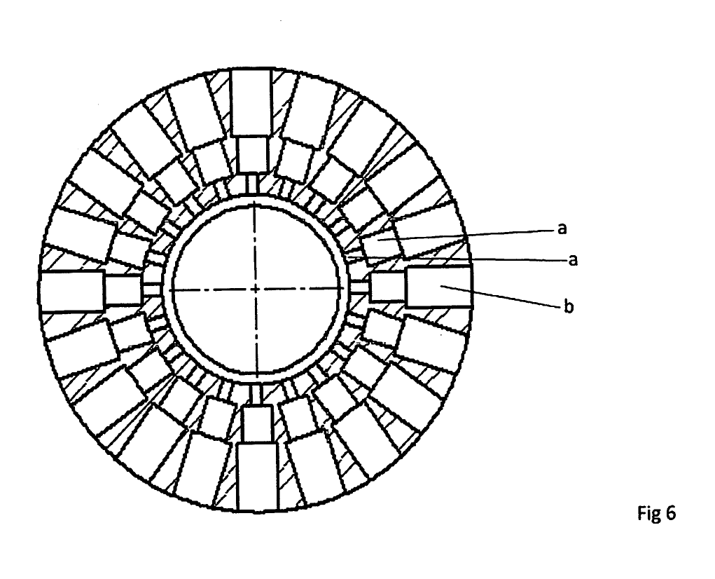

FIG. 6, section with a plan I-I from FIG. 5;

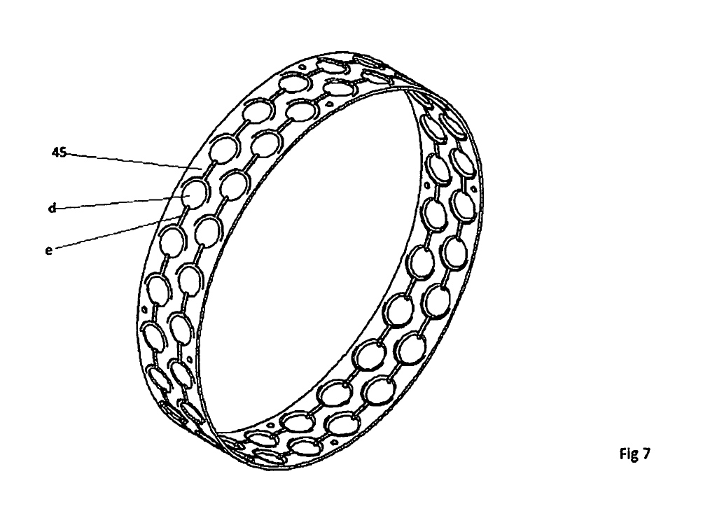

FIG. 7, perspective view of the retaining ring pos. 45;

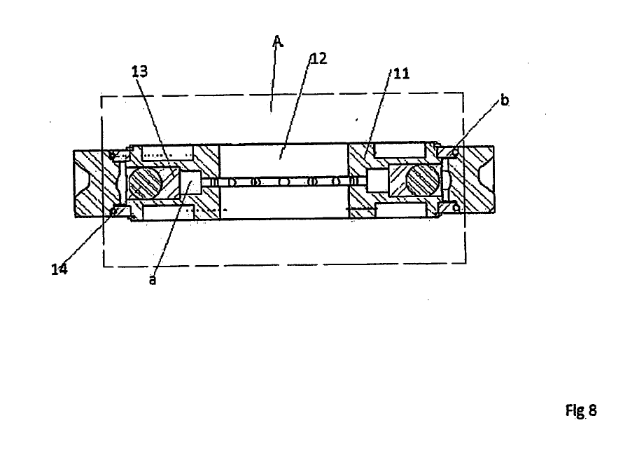

FIG. 8, axial view through the coupling with one row of balls pos. A;

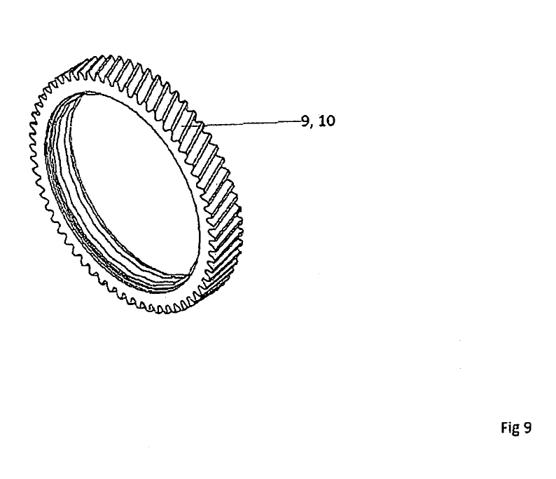

FIG. 9, perspective view of the crown wheels pos. 9, 10, 17 and 18;

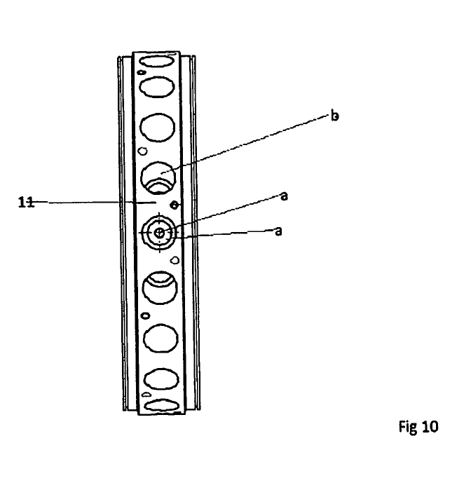

FIG. 10, lateral view of the drum pos. 11;

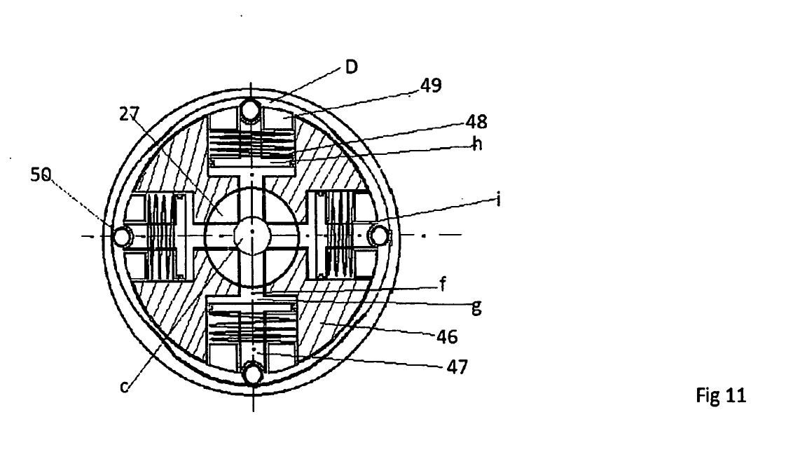

FIG. 11, axial section through ball coupling D;

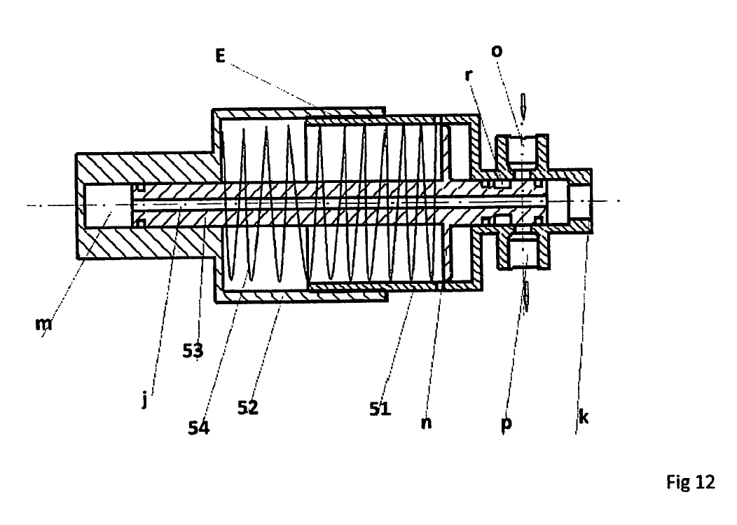

FIG. 12, axial section through the pressure regulator E;

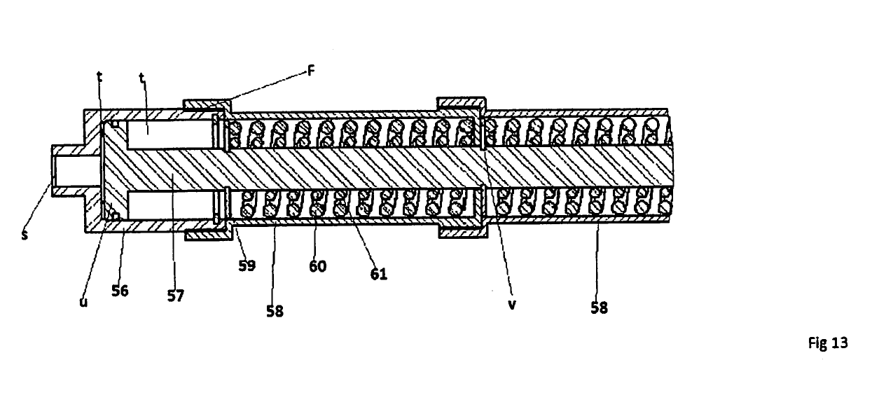

FIG. 13, axial section through the hydraulic accumulator F;

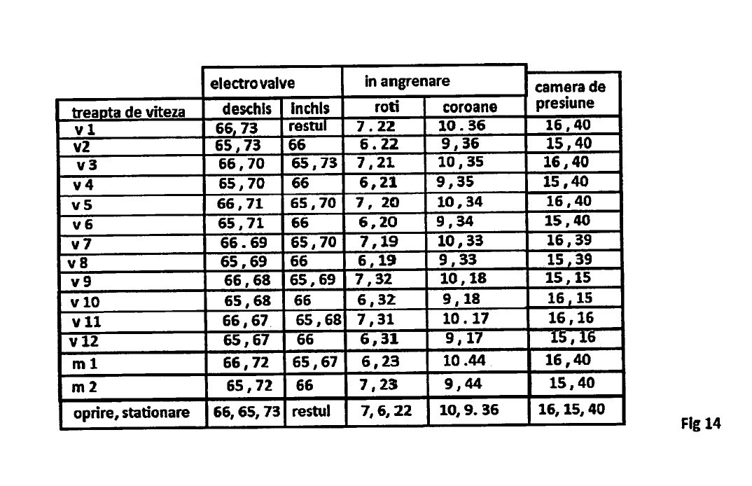

FIG. 14, explanatory table with gear engaging, according to the invention.

The automatic gearbox, according to the invention, is made up of a ball hydraulic clutch 1 provided with a toothed wheel 2 which engages the toothed wheel 3 of the oil pump 4. Also, the ball hydraulic clutch is tied in with a primary shaft 5 which, in its turn, is tied in with some toothed wheels 6 and 7 and sits on a conic bearing 8.

The toothed wheels 6 and 7 engage two wheel crowns 9 and 10 of some freewheeling clutches with pressure balls A. Inside each of these there is a drum 11 tied in with an intermediary shaft 12; the drum 11 is provided with some radial holes a, in steps, of different radiuses, inside which glide some pistons 13, each provided with a sealing ring (not represented) and a seat b in which are placed some pressure balls 14.

Also, on the intermediary shaft 12 are mounted some pressure chambers 15 and 16, with one and respectively two hydraulic circuits. On the intermediary shaft 12 are also mounted other crown wheels 17 and 18 which sit on freewheeling clutches (not represented) and some toothed wheels 19, 20, 21, 22 and 23. The intermediary shaft 12 sits on some conic bearings 24, 25 and 26 and is provided with grooves (not represented) which make the connection between the pressure chambers 15 and 16 and the drums of the above-mentioned freewheeling clutches.

The automatic gearbox, according to the invention, is also provided with a final shaft 27 which sits on the conic bearings 28, 29 and 30 and has mounted on it the toothed wheels 31 and 32, as well as the wheel crowns 33, 34, 35, 36 and 44, sitting on the freewheeling clutches B, C and D. The drums of the freewheeling clutches B are provided with pistons 37 and balls 38, arranged in two intercalated rows. The wheel crown 33 sits on the freewheeling clutch C on three rows similar constructively with clutches A and B. On the final shaft 27 is mounted also a coupling of pressure balls D which belongs to the wheel crown 44 and has the drum 46 tied in with the final shaft 27. The drum 46 is provided with a row of radial grooves f which correspond to the radial rectangular seats g through which glide the cylindrical pistons 47 which end with a rectangular section h provided with a sealing gasket. These pistons 47 are pressed by the spiral springs 48, each sitting on a rectangular metal element 49 which has an axial groove i through which the cylindrical section of the cylindrical pistons 47 glides. These rectangular elements h close the rectangular seats g from the outside of the drum 46. Due to the large surface of the rectangular section h of the cylindrical pistons 47, the oil pressure assures a corresponding force on the balls 50. Due to this technical solution, the number of balls 50 is reduced considerably, which leads to the reduction of the entire coupling ensemble.

These crown wheels 33, 34, 35, 36 and 44 gear up with the toothed wheels 19, 20, 21, 22 and 23 to the intermediary shaft 12, and the toothed wheels 31 and 32 are gear up to crown wheels 17 and 18 of the intermediary shaft 12.

Also, the final shaft 27 is provided with a pressure chamber 39 with one single hydraulic circuit and a block of four different pressure chambers 40 which are in connection with some groove systems c, which are connected with the circular grooves 41 and the radial grooves 42, in steps, made through the drums 43 and 46 of the freewheeling clutches B, respectively D.

In each of the four types of freewheeling clutches A, B, C and D, the position of the balls 14, 38 and 50 is limited radially with the help of the limiting rings 45. The rows of holes d in these correspond to the number of rows of balls and have stopping arms e cut out in the above-mentioned rings, so that these are elastic, to retain the balls 14, 38 and 50.

The automatic gearbox, according to the invention, also includes a pressure regulator E which is made up of two cylindrical elements, a main element 51 and a secondary element 52, which are assembled with each other by threading. Inside and along their axes there is a gliding rod 53 which translates. The gliding rod 53 has an axial groove j which allows the pressure oil to pass through a threaded port k in the main element 51 into the reservoir m of the secondary element 52. The gliding rod 53 is also provided with a stopping disc n which is pressed by a spiral spring 54, which sits on the secondary element 52.

Due to the fact that the ends of the gliding rod 53 are in the main element 51, respectively the secondary element 52, and the pressure of the oil presses on these ends which have different diameters, the gliding rod 53 is placed continuously within the reservoir m of the secondary element 52. Since the spiral spring 54 is pressed on the stopping disc n, the gliding rod 53 moves towards the threaded port k of the main element 51, opening the circuit of the oil, which is aspirated into a threaded port o towards another threaded port p by the oil pump 4. This access is allowed through the circular groove r in the gliding rod 53. The oil pump 4 sends the pressure oil towards the hydraulic accumulator F and the hydraulic distributor 55 which includes a group of solenoid valves which open and close the oil circuit to the pressure chambers 15 and 16, respectively 39 and 40, thus allowing the gears to be engaged and disengaged, the vehicle to go in reverse and to park.

The hydraulic accumulator F is placed and attached to the high pressure hydraulic circuit between the oil pump 4 and the hydraulic distributor 55. Its role is to store the quantity of pressure oil required for gears coupling and to take over a part of the mechanical shocks generated through gear changing.

The hydraulic accumulator F includes a cylindrical element 56 provided with a threaded port s through which the pressure oil coming through a pipe into the storing reservoir t of the oil. The volume of oil is pressed by a gliding rod 57 provided with a piston u which glides inside reservoir t.

Back to the cylindrical element 56, this is assembled by threading on the outside with a number of secondary elements 58, threaded among them which form a tubular ensemble. Inside this tubular ensemble, along its axis, is the gliding rod 57 which has on it some circular grooves v into which the plates 59 are mounted. These are pressed by the spiral springs 60 and 61, grouped concentrically in pairs, and sit independently on the end of each element of the tubular ensemble. In the end all the spring groups 60 and 61 form a couple of forces which propagate on the piston u at the end of the gliding rod 57.

Below is presented the operation of the automatic gearbox, according to this invention. When the engine is started, the hydraulic bearing clutch 1 is engaged. This in its turn sets the oil pump 4 working through the wheels 2 and 3. When the acceleration pedal is pressed, the speed of the engine, and therefore that of the hydraulic bearing clutch 1, increases. The clutch sends the pressure oil to the regulator G, whose setting depends on the capacity of the vehicle's load. This clogs the ports, which leads to an increased pressure within the circuit of the ball clutch 1.

At the same time the primary shaft 5 is set into rotation. Sensing the same speed between the PTO shaft 62 and the primary shaft 5, the board computer shuts the solenoid valve 63 and implicitly the pressure oil circuit, leaving the PTO shaft 62 and the primary shaft 5 on. During this time the oil pump 4 engaged continuously sucks in the oil through the admission valve through a pipe attached to ports p and o of the hydraulic regulator E and through another pipe into the cooling compartment 64, leading the oil through the discharge valve to the hydraulic accumulator F and the hydraulic distributor 55 and implicitly to solenoid valves 65, 66, 67, 68, 69, 70, 71, 72 and 73. When the engine exceeds a certain number of rotations, the computer opens the solenoid valve 66, sends the pressure oil to the pressure chamber 16 belonging to crown wheel 10, and the solenoid valve 73 to the pressure chamber 40 belonging to the crown wheel 36, thus realising the rigid coupling of these. This contact allows the torque from the primary shaft 5 to be transmitted through the intermediary shaft 12 to the final shaft 27 and thus to the outlet clutch, engaging the first gear and starting the vehicle. When the vehicle runs at a certain speed, the computer senses it and opens the solenoid valve 65 which sends the pressure oil to the pressure chamber 15 which belongs to crown wheel 9 and from here to its drum which couples it with the toothed wheel 6.

During this time the computer shuts the solenoid valve 66, and the pressure of the oil in the drum belonging to the crown wheel 10 is released through a pipe attached to the cooling compartment 64, uncoupling the first gear and coupling the second gear. This process takes place instantaneously. If the gas pedal is pressed on and thus the speed of the vehicle increases, the process of gear coupling and uncoupling is resumed.

When the vehicle is stopped, whether this happens on a horizontal surface or on a slope, the sensor mounted on the final shaft 27 senses the stopping and transmits the information to the board computer which engages gears 1 and 2, which leads to blocking the gearbox. In order to start the vehicle again, press the acceleration and the rotation speed of the primary shaft 5 increases. In the meantime the board computer is announced through a rotation sensor, the second gear is disengaged and the vehicle can start in the first gear and then in other gears, depending on the way in which the acceleration and the brake pedals are pressed.

1. Automatic gearbox, characterised through the fact that it is made up of a ball hydraulic clutch (1) tied in with a primary shaft (5) provided with toothed wheels (6 and 7) which engage some crown wheels (9 and 10) of some freewheeling clutches (A) with pressure balls which are mounted on an intermediary shaft (12). On this shaft are also provided some crown wheels (17 and 18), as well as some toothed wheels (19, 20, 21, 22 and 23) tied in with these. Both the crown wheels (17 and 18), and the toothed wheels (19, 20, 21, 22 and 23) on the intermediary shaft (12) engage the toothed wheels (31 and 32) and crown wheels (33, 34, 35, 36 and 44) of some freewheeling clutches (B, C and D) on the final shaft (27). The two shafts (12 and 27) are provided with pressure chambers (15, 16, 39 and 40) connected hydraulically and supplied with pressure oil from a hydraulic distributor (55) provided with a hydraulic accumulator (F) and a pressure regulator (E) connected to an oil pump (4) which is equipped with a toothed wheel (3) engaged by another toothed wheel (2).

2. Automatic gearbox characterised, according to claim 1 above, through the fact that the drums (11) belonging to crown wheels (9, 10, 17 and 18) are provided with some radial holes (a), in steps, of different radiuses in which glide some pistons (13), each provided with a seat (b) in which are placed some pressure balls (14) which are retained radially by a limiting ring (45).

3. Automatic gearbox characterised, according to claim 1 above, through the fact that the drums (43) belonging to the crown wheels (34, 35 and 36) are provided with pistons (37) and balls (38) arranged in two rows intercalated at half a step.

4. Automatic gearbox characterised, according to claim 1 above, through the fact that the drum belonging to the crown wheel (33) is provided with three rows of pistons and balls, the middle row being deviated by half a step from the lateral rows.

5. Automatic gearbox characterised, according to claim 1 above, through the fact that the freewheeling clutch (D) mentioned above, belonging to the crown (44), which also has a drum (46), is provided with a row of radial grooves (f) corresponding to the radial rectangular seats (g) through which some cylindrical pistons (47) with a rectangular end (h) glide, and are pressed by the spiral springs (48) sitting each on a metal rectangular element (49) which has provided an axial groove (i), the cylindrical pistons (47) being in contact with some balls (50).

6. Automatic gearbox characterised, according to claim 1 above, through the fact that the pressure regulator (E) includes a main element (51) and a secondary element (52) assembled by threading. Inside these, along their axis there is a gliding rod (53) provided with a stopping disc (n) which is pressed by a spiral spring (54) sitting on the secondary element (52). Inside the rod (53) there is an axial groove (j) which allows the passage of the oil from the threaded port (k) of the main element (51) into the reservoir (m) of the secondary element (52).

7. Automatic gearbox characterised, according to claim 1 above, through the fact that the hydraulic accumulator (F) is made up of a cylindrical element (56) provided with a threaded port (s) and a reservoir (t) in which the pressure oil is stored, the cylindrical element (56) being assembled by threading with a number of secondary elements (58) threaded among them. Inside and along their axes there is a gliding rod (57) provided with a piston (u) which glides inside the cylindrical elements (56), and the gliding rod (57) also has on it some circular grooves (v) into which are coupled some plates (59). Some spiral springs (60 and 61) grouped in pairs and sitting independently on the secondary elements (58), forming a force couple, press on these plates.
